(19) United States
(12) Patent Application Publication
(10) Pub. No.: US 2010/0314406 A1
(43) Pub. Date: Dec. 16, 2010

(54) GRAVITY FEED DISPENSERS FOR DISPLAY UNIT

(75) Inventors: Linda FELDMAN, Solon, OH (US); Gary Hodge, Rutherfordton, NC (US)

Correspondence Address: AKZO NOBEL INC., LEGAL & IP, 120 WHITE PLAINS ROAD, SUITE 300, TARRYTOWN, NY, 10591, US

(73) Assignee: Akzo Nobel Coatings International B.V., Arnhem (NL)

(21) Appl. No.: 12/755,039

(22) Filed: Apr. 6, 2010

Related U.S. Application Data
(60) Provisional application No. 61/185,783, filed on Jun. 10, 2009.

(51) Int. Cl. B65G 59/00

(52) U.S. Cl. 221/303

(57) ABSTRACT

The present invention provides gravity feed dispensers for use in display units. The display units may display paint and paint related products. The display unit can have a plurality of pockets to display paint chips and a plurality of dispensers to dispense a plurality of paint testers. Paint testers may roll to the front of the dispensers by gravity for selection by consumers.

### BACKGROUND OF THE INVENTION

The present invention relates to gravity feed dispensers for display units.

### SUMMARY OF THE INVENTION

The present invention provides gravity feed dispensers for use in display units. For non-limiting example, the display units may display paint and paint related products, such as paint chips and paint testers. In some embodiments of the invention, the display unit has a plurality of pockets to display paint chips and a plurality of dispensers to dispense a plurality of paint testers.

### BRIEF DESCRIPTION OF THE DRAWINGS

FIG. 1 illustrates a side view of two dispensers prior to connection;

FIG. 2 illustrates a perspective view of a two rows of dispersers prior to connection to each other;

FIG. 3 illustrates a side view of two dispensers subsequent to connection to each other;

FIG. 4 illustrates a perspective view of a two rows of dispensers subsequent to connection to each other;

FIG. 5 illustrates a perspective view of a row of six dispensers;

FIG. 6 illustrates a side view of a column of three dispensers subsequent to connection to each other and placement of the dispensers in a display unit; and

FIG. 7 illustrates a perspective view of a display unit having twelve compartments each with connected dispensers.

### DETAILED DESCRIPTION OF THE INVENTION

As used in the afore-discussed embodiments and other embodiments of the disclosure and claims described herein, the following terms generally have the meaning as indicated, but these meanings are not meant to limit the scope of the invention if the benefit of the invention is achieved by inferring a broader meaning to the following terms.

Also herein, “a,” “an,” “the”, “at least one”, and “one or more” are used interchangeably.

Also herein, the term “comprises” and variations thereof do not have a limiting meaning where these terms appear in the description and claims.

The terms “for example”, “without limitation” and the like, as well as the exemplary compounds, ranges, parameters and the like disclosed throughout the application and claims are intended to identify embodiments of the invention in a non-limiting manner. Other compounds, ranges, parameters and the like can be employed by those skilled in the art without departing from the spirit and scope of the invention.

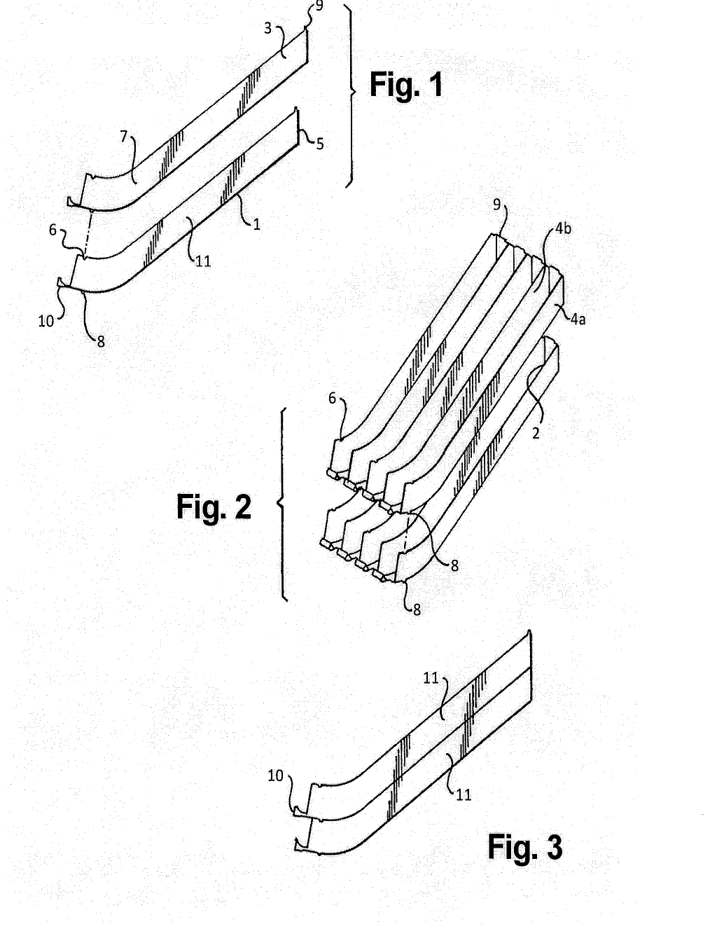

As illustrated for example in FIGS. 1, 2 and 5, the dispenser 11 in some embodiments of the invention comprises a bottom surface 1 comprising a slot 2 formed in a rear section 3 of the dispenser 11 and a projection 8 formed in a front section 7 of the dispenser 11. As illustrated in FIG. 1 for example, the rear section 3 of the dispenser 11 is the area located toward the back of the dispenser 11 and the front section 7 of the dispenser 11 is the area located on the opposite end of the rear section 3. A first sidewall 4a and a second sidewall 4b each extend upward from the bottom surface 1. A back surface 5 connects the bottom surface 1 and the sidewalls 4a, 4b in the rear section 3 of the dispenser 11. The first or second sidewall 4a, 4b comprises a notch 6 formed in a top portion of a front section 7 of the dispenser 11. The notch 6 of a first disperser 11 receives the projection 8 of a second disperser 11 when the second dispenser 11 is disposed on the first dispenser 11. The back surface 5 comprises a tongue 9, such that the tongue 9 of the first dispenser 11 fits into the slot 2 of the second dispenser 11 or through the slot 2 of a third dispenser 11 when the second dispenser 11 or the third dispenser 11 is disposed on the first dispenser 11.

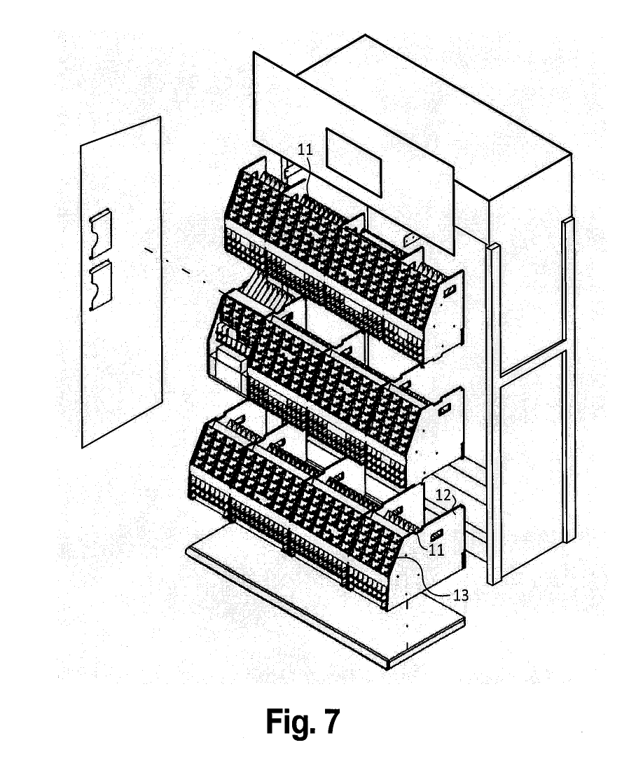

In some embodiments of the invention, multiple dispensers 11 are disposed on top of each other to form a first stack of dispensers 11 as illustrated in FIG. 3 for example. FIGS. 3 and 4 illustrate up to three stacked dispensers; however, the current invention is not so limited. In some embodiments, at least a second stack of dispensers 11 is disposed adjacent the first stack of dispensers 11 to form rows and columns of dispensers 11 as illustrated in FIGS. 4 and 7 for example.

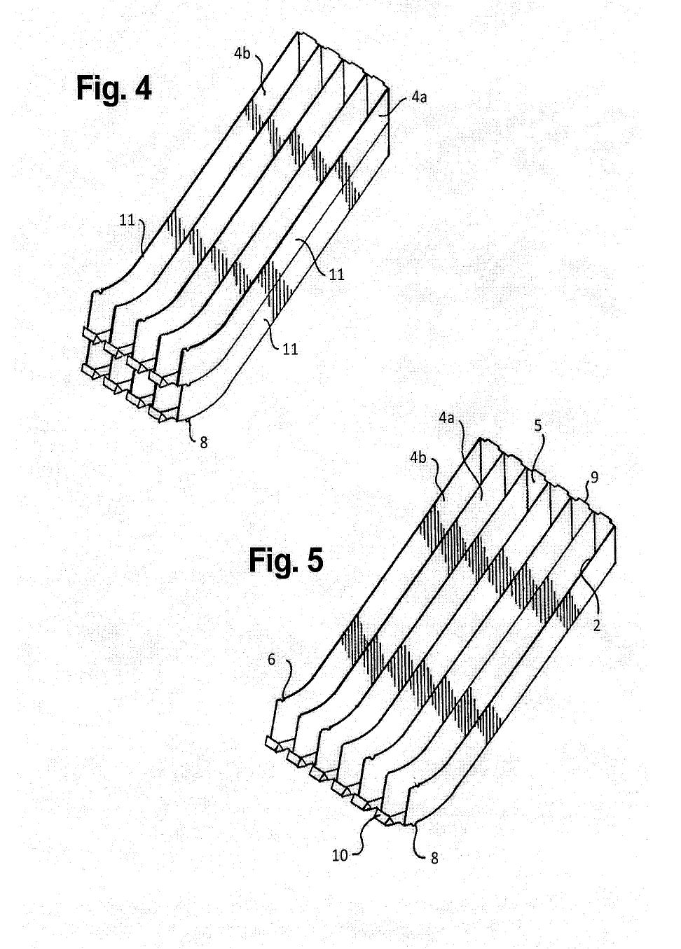

As illustrated in FIG. 5 for example, the slot 2 can be oriented substantially perpendicular to sidewalls 4a, 4b. Similarly, as illustrated in FIGS. 2 and 4 for example, the projection 8 can be oriented substantially perpendicular to sidewalls 4a, 4b.

FIG. 1 illustrates an embodiment where the rear section 3 is inclined at approximately a 45° angle with respect to the front section 7. In some embodiments of the invention, the angle formed between the rear section 3 and the front section 7 is between 0-90° , more particularly 30° or 60°.

A lip 10 may extend outward from the bottom surface 1 and away from first and second sidewalls 4a, 4b in the front section of the dispenser as illustrated in FIGS. 1 and 3 for example. The lip may be employed to catch material which is being dispensed by dispenser 11.

As illustrated in FIGS. 2 and 5 for example, a tongue 9 may be provided on the interior of the back surface 5. In some embodiments, the tongue 9 is provided on the exterior of the back surface 5. In some embodiments, the tongue 9 extends above sidewalls 4a, 4b as illustrated in FIGS. 1 and 3 so that the tongue 9 of a first dispenser can fits into slot 2 of a second dispenser disposed on the first dispenser.

In some embodiments, more than three dispensers are stacked together.

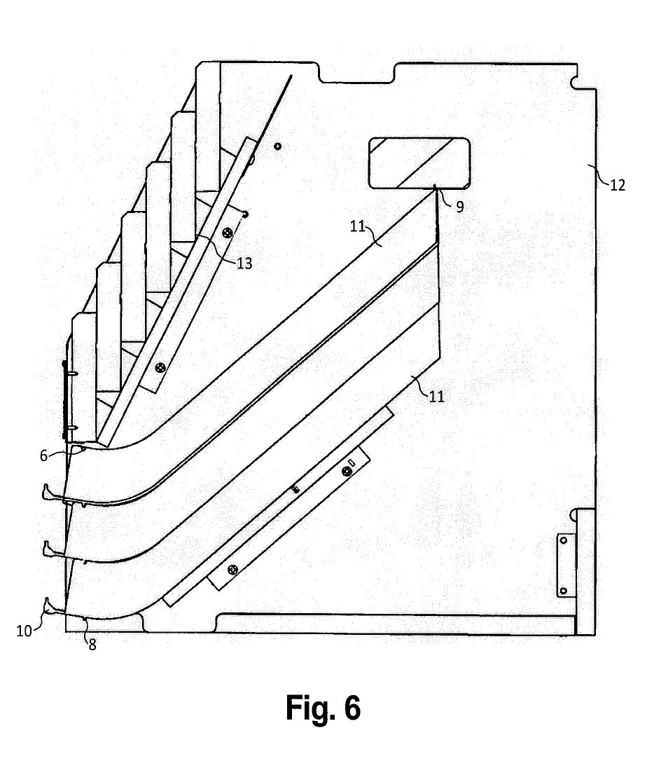

As illustrated in FIG. 7, in some embodiments the dispensers of the present invention have use in display units. They are particularly advantageous in that they allow use to be made of space behind display panels in display units, as illustrated in FIG. 6 for example. FIG. 6 is a cut-away view of a display unit having three dispensers 11 connected to each other and placed in a display unit by mounting on a display unit panel 12. Again referring to FIG. 6, stacked dispensers fit into the open space behind the display panel 13. Display panel 13 in FIG. 6 is adapted to hold paint chips; however, display panel 13 is not so limited and may be adapted for non-limiting example, to hold brochures or other materials or be an informational panel, monitor or screen.

In some embodiments of the invention, as illustrated in FIG. 3 for example, the back surface of the first dispenser and the back surface of a second dispenser are planar when the second dispenser is disposed on the first dispenser.

Consumers may select paint testers by grabbing the foremost tester in the front section 7 of a dispenser 11. When a tester is removed, gravity will force the next tester to the foremost position. Paint testers can be replenished by addition to the rear section 3 of dispensers 11.

The dispensers of the present invention may be employed to dispense paint tester bottles in display units for paint. However, the dispensers of the invention may be employed to dispense materials in other fields.

What is claimed is:

1. A dispenser for a display unit, comprising
a) a bottom surface comprising a slot formed in a rear section of the dispenser and a projection formed in a front section of the dispenser;
b) a first and a second sidewall each extending upward from the bottom surface; and
c) a back surface that connects the bottom surface and the sidewalls in the rear section of the dispenser,
wherein the first or second sidewall comprises a notch formed in a top portion of a front section of the dispenser, such that the notch of a first disperser receives the projection of a second disperser when the second dispenser is disposed on the first dispenser, and
wherein the back surface comprises a tongue, such that the tongue of the first dispenser fits into the slot of the second dispenser when the second dispenser is disposed on the first dispenser.

2. The dispenser of claim 1, wherein the slot is perpendicular to the sidewalls.

3. The dispenser of claim 1, wherein the projection is perpendicular to the sidewalls.

4. The dispenser of claim 1, wherein the rear section is inclined with respect to the front section.

5. The dispenser of claim 1, further comprising a lip extending from the bottom surface in the front section of the dispenser.

6. The dispenser of claim 1, wherein the tongue is provided on the interior of the back surface.

7. The dispenser of claim 1, wherein the tongue extends above the sidewalls.

8. The dispenser of claim 1, wherein the back surface of the first dispenser and the back surface of a second dispenser are planar when the second dispenser is disposed on the first dispenser.
